(19) United States
(12) Patent Application Publication
(10) Pub. No.: US 2007/0297497 A1
(43) Pub. Date: Dec. 27, 2007

(54) Apparatus And Method For Interference Cancellation

(76) Inventors: Cristina A. Seibert, Mountain View, CA (US); Dominic Gerard Farmer, Los Gatos, CA (US); Michael James Wengler, Carlsbad, CA (US)

Correspondence Address: QUALCOMM INCORPORATED, 5775 MOREHOUSE DR., SAN DIEGO, CA, 92121, US

(21) Appl. No.: 11/766,035

(22) Filed: Jun. 20, 2007

Related U.S. Application Data
(60) Provisional application No. 60/815,666, filed on Jun. 21, 2006.

(51) Int. Cl. H04B 1/00

(52) U.S. Cl. 375/148

(57) ABSTRACT

An apparatus and method for interference cancellation using software or low speed hardware. Antenna signals are received and selected. After selection, interference cancellation processing is applied. In one embodiment, the signal is a spread spectrum signal and selection includes despreading the signal. In one example, the interference cancellation processing includes a phase rotation step and a magnitude manipulation step.

### CROSS-REFERENCE TO RELATED APPLICATIONS

The present application claims priority to U.S. Provisional Application No. 60/815,666, entitled, “Low-cost methods for interference cancellation in spread-spectrum systems” filed on Jun. 21, 2006, which is assigned to the assignee hereof and which is expressly incorporated herein by reference.

### FIELD

This disclosure relates generally to apparatus and methods for interference cancellation.

### BACKGROUND

In wireless communication systems, signal interference from multiple sources or multiple paths is a common problem. Signal interference affects the signal quality as received by a receiver. Interference cancellation is a technique that is used at a wireless receiver to increase the signal-to-noise ratio and thus to enhance the detection and/or decoding of that signal.

Various techniques for interference cancellation are used in wireless communication systems. These techniques involve the incoming signal sample stream being analyzed and processed to remove interference. The resulting new signal sample stream is then fed to the receiver detection and or decoding logic for its additional processing in recovering the original signal.

One technique for interference cancellation includes “minimum antenna combining.” In the “minimum antenna combining” technique, input streams from multiple antennas are added in such a way as to destructively combine the signal from a dominant source. This lowers the noise floor and thus allows weaker signals at a power level that was originally below the noise floor to become detectable.

Another technique for interference cancellation includes subtracting the power level associated with various signals that have been previously detected and/or decoded. This, in turn, similarly lowers the noise floor and thus allows weaker signals at a power level that was originally below the noise floor to become detectable.

These techniques for interference cancellation require that the input stream be processed in advance of the signal despreading. For example, performing interference cancellation prior to signal despreading necessitates processing individual samples typically at speeds in the MHz range as opposed to the kHz or Hz range. Hardware operating at the MHz range is typically more complex and more costly than hardware operating at the kHz or Hz range. Performing interference cancellation prior to signal despreading also requires storage of such samples received. In systems where individual samples are processed in hardware, the interference cancellation techniques are implemented in special purpose hardware blocks.

Accordingly, it is desirable to provide a apparatus and a method for interference cancellation where the processing speed is at a lower frequency range. Additionally, it is desirable to provide a apparatus and a method for interference cancellation where there is minimal or no storage requirement. Further, it is desirable to provide a apparatus and a method for interference cancellation where there the interference cancellation can be implemented in software without the use of special purpose hardware blocks.

### SUMMARY

Disclosed is an apparatus and method for interference cancellation. According to one aspect, a receiver system for processing interference cancellation comprises a pre-selection processing unit for processing a signal; a selector coupled to the pre-selection processing unit for selecting the signal, and an interference canceller for performing interference cancellation on the signal outputted from the selector. In one embodiment, the interference canceller comprises a hardware unit for performing interference cancellation on the signal. In another embodiment, the hardware unit comprises a phase module and a magnitude module. In one embodiment, the signal is a spread-spectrum signal, and the selector is a despreader. In one embodiment, a coherent integrator is coupled to selector for coherently integrating the signal outputted from the selector.

According to another aspect, a method for interference cancellation comprises pre-processing a signal; selecting the signal, and performing interference cancellation processing on the signal after selecting the signal.

It is understood that other embodiments will become readily apparent to those skilled in the art from the following detailed description, wherein it is shown and described various embodiments by way of illustration. The drawings and detailed description are to be regarded as illustrative in nature and not as restrictive.

### BRIEF DESCRIPTION OF THE DRAWINGS

FIG. 1 is a block diagram illustrating a spread spectrum telecommunication system.

FIG. 2 is an illustration of a transmit and receive system for spread-spectrum signals.

FIGS. 3 and 4 illustrate block diagrams of a receiver system.

FIG. 5 is a flow diagram for performing interference cancellation.

FIG. 6 illustrates the use of a conventional two antenna system for interference cancellation.

FIG. 7 is an example illustrating the use of a two antenna system for interference cancellation with antenna weighting occurring after signal despreading and coherent integration.

FIG. 8 is another example of the two antenna system for interference cancellation of FIG. 7 where the antenna weighting is decomposed into a phase rotation step and a magnitude manipulation step.

FIG. 9 is a graph comparing the effectiveness of the interference cancellation scheme with antenna weighting occurring after signal despreading and coherent integration to a conventional interference cancellation scheme.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention.

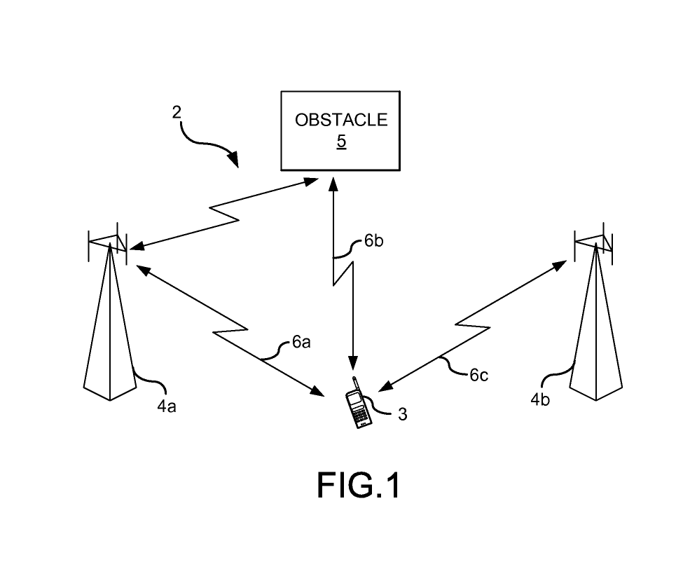

FIG. 1 is a block diagram illustrating a spread spectrum telecommunication system 2 in which subscriber unit 3 receives a number of spread spectrum signals 6a, 6b, 6c. In particular, subscriber unit 3 receives signal 6a from base station 4a. Subscriber unit 3 also receives signal 6b which is caused by the reflection of signal 6a from obstacle 5. Additionally, subscriber unit 3 receives a spread spectrum signal 6c from base station 4b. Subscriber unit 3 can, for example, include a mobile wireless communication telephone, a satellite radio telephone, a wireless communication personal digital assistant (PDA) and the like. In one embodiment, the subscriber unit 3 includes a receiver system for receiving a signal. Obstacle 5 may be any structure proximate subscriber unit 3 such as a building, a bridge, a billboard, a car and the like.

Signals 6a and 6b illustrate a multipath situation in which the same information is carried along two separate paths. In this example, because there are two paths carrying the same information, the two signals 6a and 6b may have different amplitudes, phases and time delays. Essentially, the two signals 6a and 6b interfere with each other. Additionally, subscriber unit 3 may receive signal 6c transmitted by base station 4b to another subscriber unit. Signal 6c also interferes with signals 6a and 6b. Additional interference signals, not illustrated in FIG. 1, may be received by subscriber unit 3.

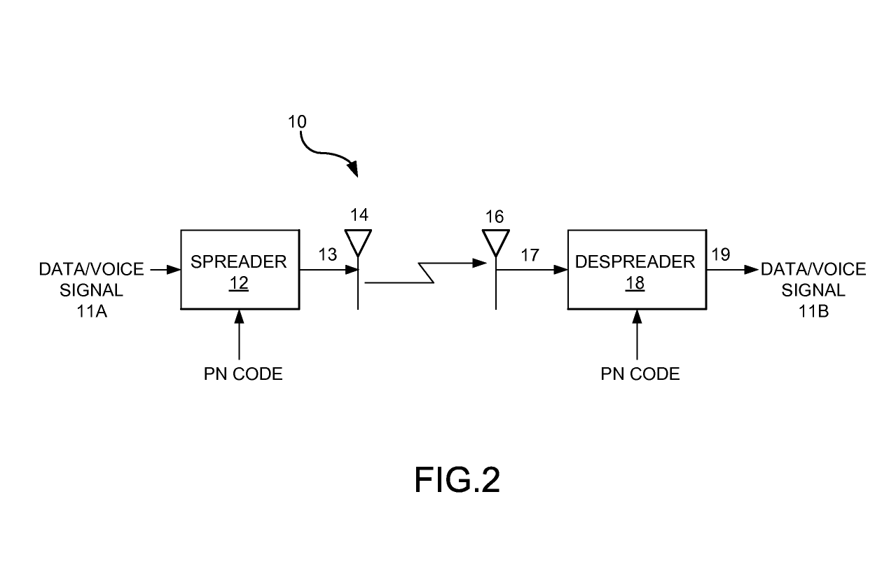

Techniques for interference cancellation are used in wireless communication systems to remove interference signals. FIG. 2 is an illustration of a transmit and receive system 10 for spread-spectrum signals. Data/voice signal 11a is inputted to a spreader unit 12 along with a pre-determined pseudo-noise code (PN code). The transmitted spread spectrum signal 13 is then transmitted by transmit antenna 14 and received by receive antenna 16. The spreader unit 12 broadens the bandwidth of the transmitted spread spectrum signal 13 exceeding the bandwidth of original data/voice signal 11a. The received spread spectrum signal 17 has the same bandwidth as the transmitted spread spectrum signal 13. The received spread spectrum signal 17 is then inputted to the de-spreader unit 18 which (ideally) recovers the data/voice signal 11a. The pre-determined pseudo-noise code (PN code) is also inputted to the de-spreader unit 18 to help recover data/voice signal 11a. Due to interference and noise introduced during transmission, the output of the de-spreader unit 19 (data/voice signal 11b) is not exactly the same as data/voice signal 11a. In one embodiment, interference is mitigated so as to recover data/voice signal 11a with minimal interference at the output of the de-spreader 18. The interference cancellation processing is performed after the de-spreader unit 18 to take advantage of the lower signal rate. Typically, the bandwidth of the received spread spectrum signal 17 is at MHz range which is greater than the bandwidth of the de-spread signal 19, typically at kHz or Hz range. By performing interference cancellation on the de-spread signal 19, the hardware for interference cancellation processing operates at the de-spread signal rate in the kHz or Hz range.

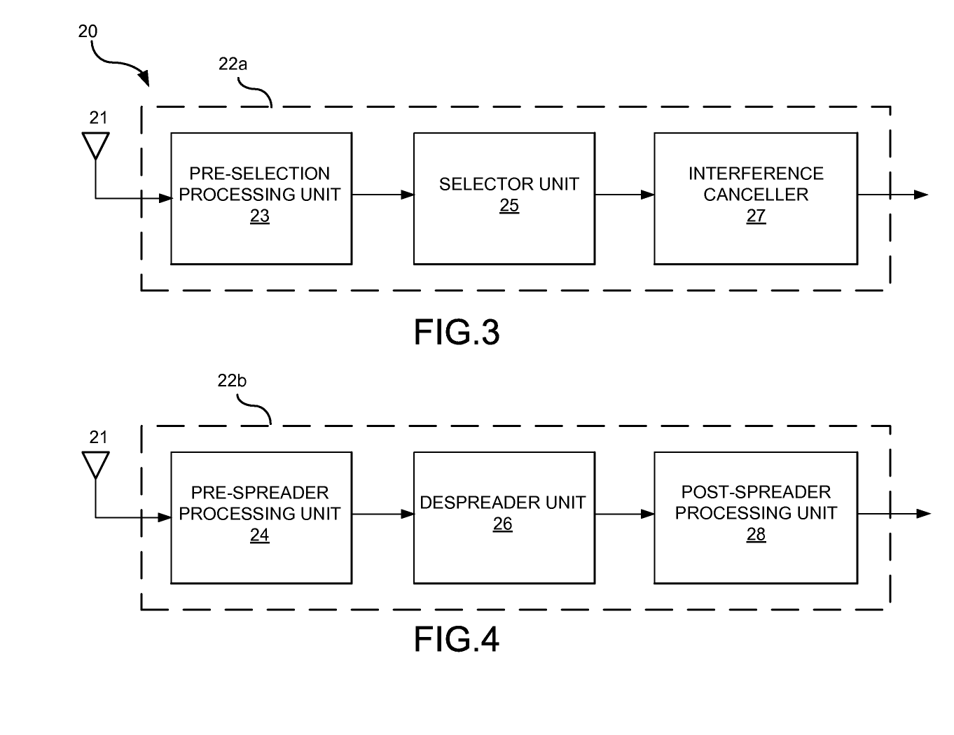

FIG. 3 is a block diagram of a receiver system 20. Receiver system 20 includes at least one antenna 21 and a receiver unit 22a. The receiver unit 22a includes a pre-selection processing unit 23 for signal processing prior to selection. An example of such processing may include, though not limited to, amplification, bandpass filtering, frequency downconversion, amplitude limiting and automatic gain control. The receiver unit 22a also includes a selector unit 25 for selecting the received signal. The specific details of the selector unit 25 for selecting the received signal depend on the multiple access technique used and the wireless propagation environment. For example, systems employing code division multiple access (CDMA) spread the bandwidth of the received signal using a PN code, and the selector unit would be a despreader to select the received signal from undesired signals and interference. Other forms of selector units may include a frequency dehopper and a time dehopper. One skilled in the art would understand that the structure of a selector unit is not limited to the examples presented here and would depend on the multiple access technique used and the wireless propagation environment. The receiver unit 22a also includes an interference canceller 27 for processing interference cancellation. In one embodiment, the interference canceller 27 also processes low pass filtering, coherent integration, signal detection and/or dc bias removal. In another embodiment, a coherent integrator 29 (not shown) coherently integrates the signal from the output of the selector unit 25 prior to interference cancellation.

In one embodiment shown in FIG. 4, the received signal is a spread spectrum signal. In this embodiment, the receiver unit 22b includes a pre-despreader processing unit 24 to perform pre-despreading processing, a de-spreader unit 26 for despreading the received spread spectrum signal and a post-despreader processing unit 28 to perform post-despreading processing. An example of pre-despreading processing may include, though not limited to, amplification, bandpass filtering, frequency downconversion, amplitude limiting and automatic gain control. In one embodiment, the post-despreader processing unit 28 includes an interference canceller 27 to perform the interference cancellation processing. In one embodiment, the post-despreader processing unit 28 also processes low pass filtering, coherent integration, signal detection and/or dc bias removal.

The various illustrative logical blocks, modules, and circuits described herein may be implemented or performed with one or more processors. A processor may be a general purpose processor, such as a microprocessor, a specific application processor, such a digital signal processor (DSP), or any other hardware platform capable of supporting software. Software shall be construed broadly to mean any combination of instructions, data structures, or program code, whether referred to as software, firmware, middleware, microcode, or any other terminology. Alternatively, a processor may be an application specific integrated circuit (ASIC), a programmable logic device (PLD), a field programmable gate array (FPGA), a controller, a micro-controller, a state machine, a combination of discrete hardware components, or any combination thereof. The various illustrative logical blocks, modules, and circuits described herein may also include machine readable medium for storing software. The machine readable medium may also include one or more storage devices, a transmission line, or a carrier wave that encodes a data signal.

The linearity of the interference cancellation and despreading processes allow processing for interference cancellation to take place after the despreading process, thus reducing the associated processing and bandwidth requirements. By performing the interference cancellation at the reduced bandwidth requirement as part of the post-despreading processing, software-based implementations can be used, including but not limited to software-only solutions known as “Software Radio.” Additionally, slower speed hardware (which are typically less complex and less costly) can be implemented for interference cancellation on a post-de-spread signal.

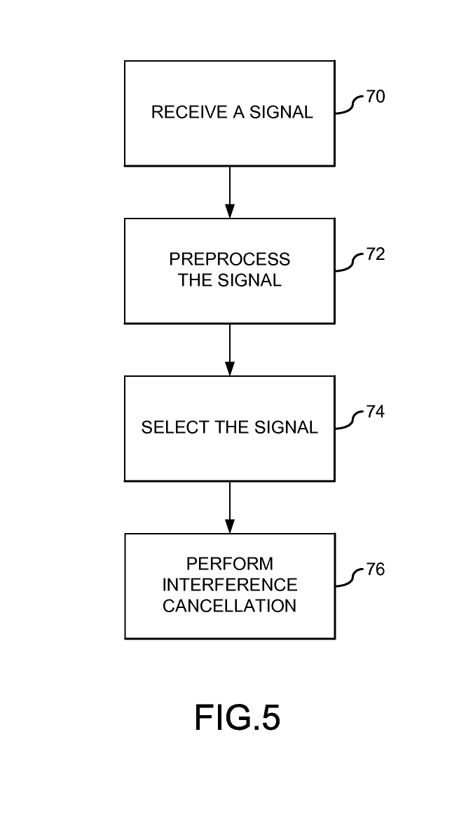

FIG. 5 is a flow diagram for performing interference cancellation. In step 70, a signal is received by at least one antenna. The received signal is then pre-processed in step 72. In one example, antenna weighting is done in step 72 as part of the pre-processing step. In step 74, the signal is selected. In one example, the signal is a spread-spectrum signal in which signal selection includes despreading the signal. In step 76, interference cancellation processing is performed on the signal to enable recovery of the original signal from the source.

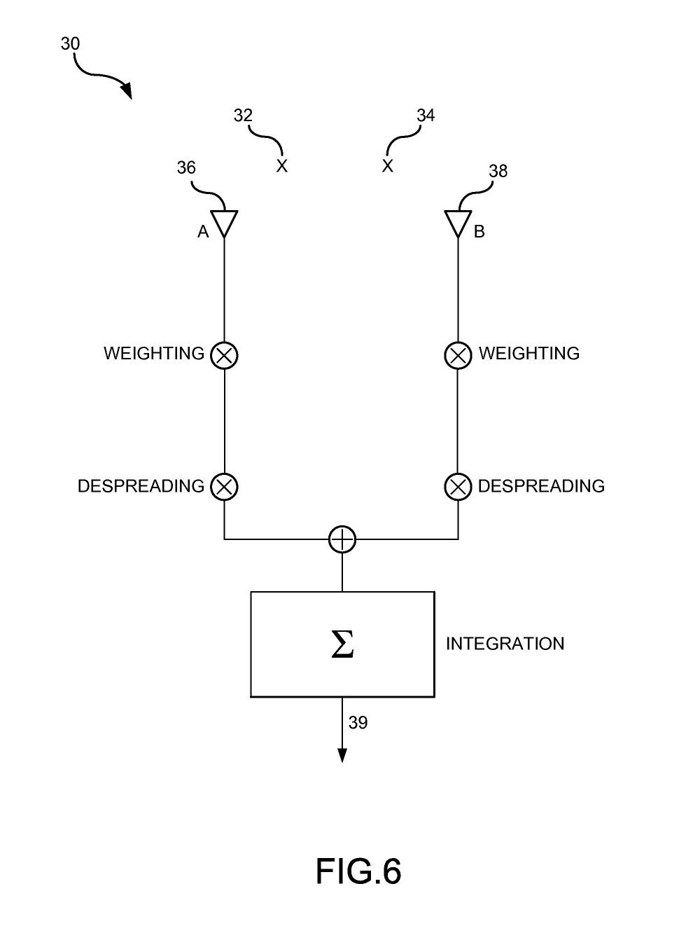

FIG. 6 illustrates the use of a conventional two antenna system 30 for interference cancellation. The two antenna system 30 includes a first antenna 36 and a second antenna 38 with the two antennas spatially offset from each other. In one example, assume that transmission source 32 is transmitting the desired signal while transmission source 34 is transmitting an interference signal. Processing of the signals (desired signal and interference signal) received by both antennas 36, 38 is used to suppress the interference signal and enhance the desired signal. Conventionally, antenna weighting is applied prior to the despreading processing which is at the faster spread spectrum rate. Referring to FIG. 6, in conventional techniques for interference cancellation, the complex weights are applied to the input stream from each antenna 36, 38 before the two streams are despread and combined into one single stream 39. In one illustration, the single stream 39 is then coherently or non-coherently integrated to recover the original signal.

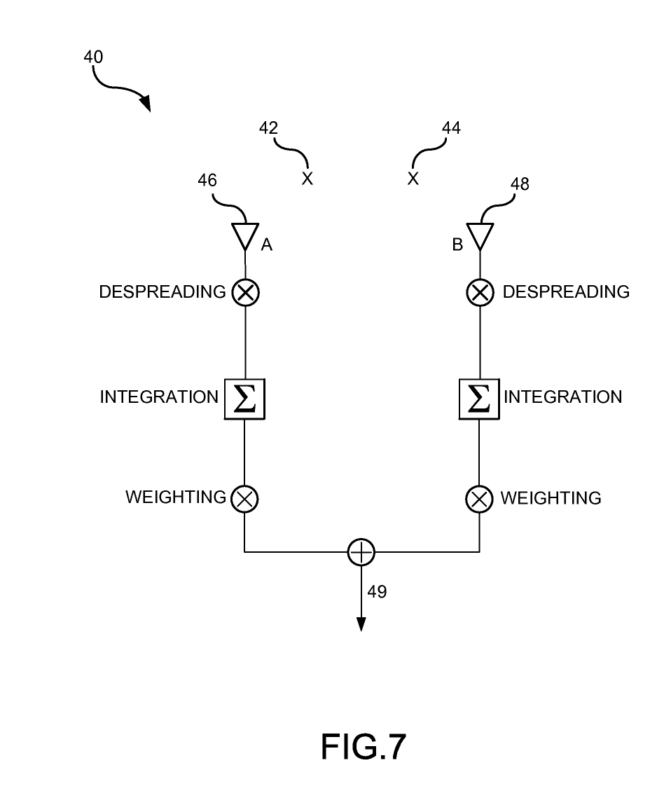

FIG. 7 is an example illustrating the use of a two antenna system 40 for interference cancellation with antenna weighting occurring after signal despreading and coherent integration. In one example, assume that transmission source 42 is transmitting the desired signal while transmission source 44 is transmitting an interference signal. Processing of the signals (desired signal and interference signal) received by both antennas 46, 48 is used to suppress the interference signal and enhance the desired signal. Here, antenna weighting is applied after the despreading processing which is at a lower rate (typically in the kHz or Hz range) than at the spread spectrum rate (typically in the MHz range). Referring to FIG. 7 the antenna weighting for interference cancellation is applied to each stream after the despreading process. In one embodiment, coherent or non-coherent integration is also applied before the antenna weighting process. The two streams are then subsequently combined into one single stream 49.

Mathematically, the complex voltage stream on antenna A (36) can be represented as i0+jq0 and the complex voltage stream on antenna B (38) can be represented as i1+jq1. The code for the signal to be searched can be represented as i2+jq2 (assuming a CDMA-like environment where each signal is represented by a code). Furthermore, assume the weights to be applied to the stream from each antenna are a0+jb0 and a1+jb1, respectively. Note that i0, q0, i1, q1, i2, q2 are vectors of some length L while a0, b0, a1, b1 are, for a stationary channel, constants over the length L. For fading channels, parameters typically vary at a rate of kHz or Hz.

The interference cancellation algorithm invokes the operation of antenna-specific weighting, followed by despreading and coherent integration over some N chips, which mathematically can be expressed as follows:

$$\begin{matrix}{\sum }_{N} \{ [ ( a 0 + j \times b 0 ) \times ( i 0 + j \times q 0 ) ] \times ( i 2 - j \times q 2 ) \} \\ for antenna A & ( 36 ) \\ {\sum }_{N} \{ [ ( a 1 + j \times b 1 ) \times ( i 1 + j \times q 1 ) ] \times ( i 2 - j \times q 2 ) \} \\ for antenna B . & ( 38 )\end{matrix}$$

Taking advantage that the interference algorithm has linearity properties, the interference cancellation processing is performed after the despreading processing has occurred. Since multiplication is associative, the body of the sums can be re-written as follows:

$$\begin{matrix}{\sum }_{N} \{ [ ( a 0 + j \times b 0 ) \times [ ( i 0 + j \times q 0 ) \times ( i 2 - j \times q 2 ) ] \} \\ for antenna A & ( 36 ) \\ {\sum }_{N} \{ [ ( a 1 + j \times b 1 ) \times [ ( i 1 + j \times q 1 ) \times ( i 2 - j \times q 2 ) ] \} \\ for antenna B . & ( 38 )\end{matrix}$$

In this example, N is chosen such that the coherent integration spans no more than on the order of 1 second. Thus, a0, b0, a1 and b1 are constant over N. This simplification allows (a0+jb0) and (a1+jb1) to be pulled outside the sums:

$$\begin{matrix}( a 0 + j \times b 0 ) {\sum }_{N} \{ [ ( i 0 + j \times q 0 ) \times ( i 2 - j \times q 2 ) ] \} \\ for antenna A . & ( 36 ) \\ ( a 1 + j \times b 1 ) {\sum }_{N} \{ [ ( i 1 + j \times q 1 ) \times ( i 2 - j \times q 2 ) ] \} \\ for antenna B . & ( 38 )\end{matrix}$$

As shown in the equations above, the sum is simply the coherent integration over N chips without any manipulations from the interference cancellation process. Thus, the antenna-specific weighting occurs after signal despreading and coherent integration. In one embodiment, the interference cancellation can be implemented using a software algorithm. In another embodiment, the interference cancellation can be implemented in hardware at lower bandwidth and processing requirements than in interference cancellation schemes where the antenna weighting occurs before signal despreading and coherent integration.

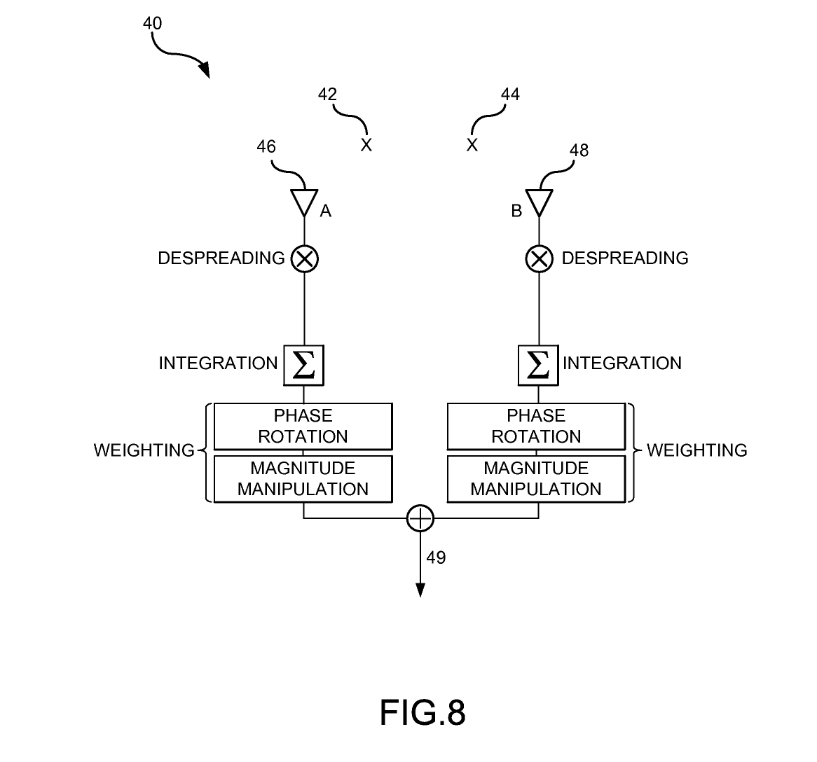

In one embodiment, the interference cancellation algorithm is decomposed into two components, phase and magnitude. These two components can be applied at different stages in the signal processing by a phase module and a magnitude module in independent manners as shown in FIG. 8. In one embodiment, the order of the complex weighting illustrated in FIG. 8 is reversed such that magnitude manipulation precedes phase rotation. In an exemplary embodiment, phase and magnitude modules already present in performing conventional signal processing are leveraged for interference cancellation. In one example, the automatic-gain-control (AGC) unit can be used for magnitude manipulation and the rotators can be used for phase manipulation.

Mathematically, the weight equation a0+jb0 can be equated to
A0[cos(tau0)+j*sin(tau0)]
where
A0=a0/cos(arctan(b0/a0)) and tau0=arctan(b0/a0),

Similarly, the weight equation a1+jb1 can be equated to
A1[cos(tau1)+j*sin(tau1)]
where
A1=a1/cos(arctan(b1/a1)) and tau1=arctan(b1/a1)

Thus the weights can be decomposed into magnitude parameters A0 and A1, respectively, and rotation parameters tau0 and tau1, respectively. In one embodiment, the associative properties of multiplication and summation are implemented. The rotation and magnitude operations are applied at different points in the computation process, allowing the use of an existing design with separate AGC and rotator blocks to be leveraged for interference cancellation purposes.

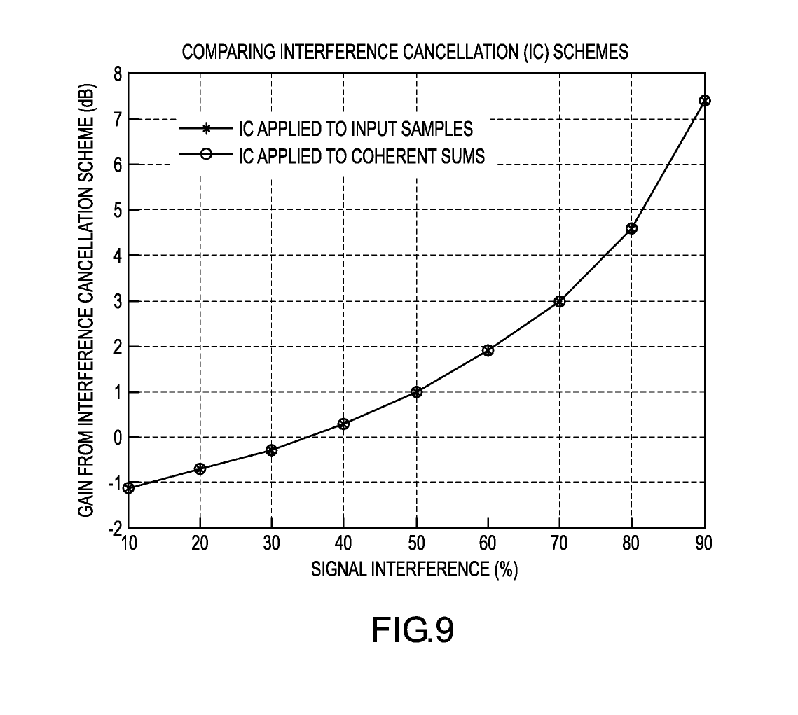

In one experiment, Matlab scripts were written to compare the effectiveness of the interference cancellation scheme with antenna weighting occurring after signal despreading and coherent integration to a conventional interference cancellation scheme. Without loss of generality, an Additive White Gaussian Noise (AWGN) environment is assumed. The sensitivity gain from interference cancellation is plotted for both schemes under various channel interference conditions. The results are shown in FIG. 9. As expected, the results for the two interference cancellation schemes are identical. This is because: 1) the measured signal energy is identical as proven mathematically and 2) the measured total received power comes directly from the smallest eigenvalue which is computed in the same fashion for both schemes.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

1. A receiver system for processing interference cancellation comprising:
a selector for selecting a signal, and
an interference canceller for performing interference cancellation on the signal outputted from the selector.

2. The receiver system of claim 1 further comprising a pre-selection unit for processing the signal.

3. The receiver system of claim 1 wherein the signal is a spread-spectrum signal.

4. The receiver system of claim 3 where in the selector is a despreader.

5. The receiver system of claim 2 wherein the pre-selection processing unit operates at a rate in the MHz range.

6. The receiver system of claim 5 wherein the interference canceller operates at a rate in the kHz or Hz range.

7. The receiver system of claim 1 wherein the interference canceller comprises a software algorithm for performing interference cancellation on the signal.

8. The receiver system of claim 1 wherein the interference canceller comprises a software radio for performing interference cancellation on the signal.

9. The receiver system of claim 1 wherein the interference canceller comprises a hardware unit for performing interference cancellation on the signal.

10. The receiver system of claim 9 wherein the hardware unit comprises a phase module and a magnitude module.

11. The receiver system of claim 10 wherein the phase module is a rotator.

12. The receiver system of claim 10 wherein the magnitude module is an automatic gain control (AGC) unit.

13. A receiver system for processing interference cancellation comprising:
a selection means for selecting a signal, and
an interference cancellation means for performing interference cancellation on the signal outputted from the selection means.

14. The receiver system of claim 13 further comprising a pre-selection processing means for processing the signal.

15. The receiver system of claim 13 wherein the interference cancellation means comprises a software algorithm for performing interference cancellation on the signal.

16. The receiver system of claim 13 wherein the interference cancellation means comprises a hardware unit for performing interference cancellation on the signal.

17. A receiver system for processing interference cancellation comprising:
a selector for selecting a signal,
a coherent integrator coupled to selector for coherently integrating the signal outputted from the selector, and
an interference canceller for performing interference cancellation on the signal outputted from the coherent integrator.

18. The receiver system of claim 17 where in the selector is a despreader.

19. A method for interference cancellation comprising:
selecting a signal, and
performing interference cancellation processing on the signal after selecting the signal.

20. The method of claim 19 further comprising receiving the signal with at least one antenna.

21. The method of claim 19 wherein the signal is a spread-spectrum signal.

22. The method of claim 21 wherein a despreader is used for selecting the signal.

23. The method of claim 19 further comprising coherently integrating the signal after selecting the signal and before performing interference cancellation processing on the signal.

24. The method of claim 23 wherein interference cancellation processing operates in the kHz or Hz range.

25. The method of claim 19 wherein a software algorithm is used for performing interference cancellation.

26. The method of claim 19 wherein a software radio is used for performing interference cancellation.

27. The method of claim 19 wherein a hardware unit is used for performing interference cancellation.

28. The method of claim 27 wherein the hardware unit comprises a phase module and a magnitude module.

29. The method of claim 28 wherein the phase module is a rotator.

30. The method of claim 28 wherein the magnitude module is an automatic gain control (AGC) unit.

31. Machine readable media embodying a program of instructions executable by a computer to perform interference cancellation, comprising:
instructions to select a signal, and
instructions to perform interference cancellation processing on the signal after selecting the signal.

32. The machine readable media of claim 31 wherein the signal is a spread spectrum signal.

33. The machine readable media of claim 31 further comprising instructions to coherently integrate the signal after selecting the signal and before performing interference cancellation processing on the signal.
